(19) United States
(12) Patent Application Publication
(10) Pub. No.: US 2026/0128020 A1
(43) Pub. Date: May 7, 2026

(54) INTEGRATED PIANO AND ENTERTAINMENT SYSTEM

(71) Applicant: William Frederick Moyer, Dover, NH (US)

(72) Inventor: William Frederick Moyer, Dover, NH (US)

(21) Appl. No.: 18/937,167

(22) Filed: Nov. 5, 2024

(51) Int. Cl. G10H 1/00; G02B 30/56; G03B 29/00; G06F 3/14; H04N 5/77

(52) U.S. Cl. CPC G10H 1/0008; G02B 30/56; G03B 29/00; G06F 3/14; H04N 5/77; G10H 2220/005

(57) ABSTRACT

The present invention pertains to the enhancement of grand pianos with integrated video and audio features, all while preserving the piano's meticulously perfected mechanics and acoustics and its timeless and elegant appearance.

### INCORPORATION BY REFERENCE

Associated References: This application hereby incorporates by reference U.S. Pat. Nos. 10,332,490 and 10,410,609.

### BACKGROUND

Many player piano systems aim to transform themselves into multimedia entertainment centers by synchronizing recorded video and audio with the automated performance of the piano keys. However, all existing systems require users to provide a separate standard display screen, distinct from the player piano. Regarding audio, some player piano systems include speakers concealed within the piano's underbelly, but while this setup works well for subwoofers, tweeters ideally should be placed higher and unobstructed. Those wishing for optimum sound quality therefore attach their own external speakers to these player piano systems. The result is a clutter of equipment and cables, detracting from the aesthetics of a home and impractical for commercial settings like hotel lobbies or bars.

Likewise, in concert settings, pianos often need amplification, entailing the setup of external equipment. Consequently, the piano becomes surrounded by microphones, speakers, and cables, which is visually unpleasing for the audience. Additionally, adjusting the piano's stage position necessitates subsequent relocation of the audio equipment.

### SUMMARY

To address these and other limitations of prior art systems, this invention enhances player pianos and concert pianos in the following ways:

### Player Piano Systems

(a) It keeps the player piano lid open to a minimum of 50 degrees relative to the horizontal plane.
(b) It incorporates an embedded video display screen within the underside of the piano lid.
(c) It embeds speakers, particularly tweeters, inside the lid.
(d) It synchronizes pre-recorded piano performances with video and audio content.

### Concert Pianos

(a) It embeds speakers, especially tweeters, into the piano lid. (It is assumed that other speakers, particularly subwoofers, would be embedded in the piano's underbelly, and microphones would be attached to the piano. These components, while not standard, are not novel.) The result is an acoustic grand piano with integrated amplification. Moreover, the piano can amplify other musicians, announcers on stage, and other audio content through simple audio jacks or electronic data transfer.
(b) Optionally, it attaches a miniature camera trained on the keys and integrates into the lid a video display screen. When the lid is raised to at least 50 degrees relative to the horizontal plane, it concurrently displays the pianist's hands and keys (or other video content) on the underside of the lid during the performance.

In certain embodiments of the invention, a projector projects the image onto a white plastic sheet that adheres to the underside of the lid through static charge.

### BRIEF DESCRIPTION OF THE DRAWINGS

FIG. 1 illustrates an exemplary player piano system with a customized lid including screen for display of video, images and text, multiple hinge assists, and speakers;

FIG. 2 illustrates an exemplary player piano system used as a home entertainment center (audio and video);

FIG. 3 illustrates an exemplary piano system with speakers, but no video display, attached to the lid;

FIG. 4 illustrates an exemplary player piano system with a vertical piano lid that raises and lowers behind the piano;

FIG. 5 illustrates an exemplary player piano system with an attached projector and camera and cup-like device to hold the extended stick;

FIG. 6 illustrates an adjustable but stable extended support stick for holding up a piano lid;

FIG. 7 illustrates an exemplary player piano system with an OLED digital display embedded in a transparent piano lid;

FIG. 8 illustrates an exemplary player piano system with altered piano lid construction and shape;

FIG. 9 illustrates a non-rectangular video display to accommodate both the 16:9 aspect ratio of a typical video and the ideal screen shape for a live concert;

FIG. 10 illustrates image manipulations which correct the unique visual distortions caused by the screen angle;

FIG. 11 illustrates the software interface used to mask the image when projecting the piano keys and hands on a customized screen;

FIG. 12 illustrates a tablet enclosure for a smart tablet used to mask and manipulate the image;

FIG. 13 illustrates a plate connecting the projector to a camera mount when a projector is employed;

FIG. 14 illustrates a hologram-like 3D image of a pianist playing a modern player piano system.

### DETAILED DESCRIPTION

Preliminary: A “piano lid”is defined herein as:
(a) A table-top-like flat surface attached to the long straight far side of a piano.
(b) At its greatest length, the lid must be more than 1/2 the length of the piano.
(c) At its greatest width, the lid must be approximately the same width as the piano at its widest point.
(d) In its “concert position,” the side that is not attached to the piano is raised up.

Given the above definition, a piano lid does not need to conform to the curved shape of the piano—for example, the lid can be rectangular. A piano lid does not need to have a shut position—it can remain in an open position. In its “concert position,” the angle of the piano lid relative to the horizontal floor can be between 30 and 90 degrees.

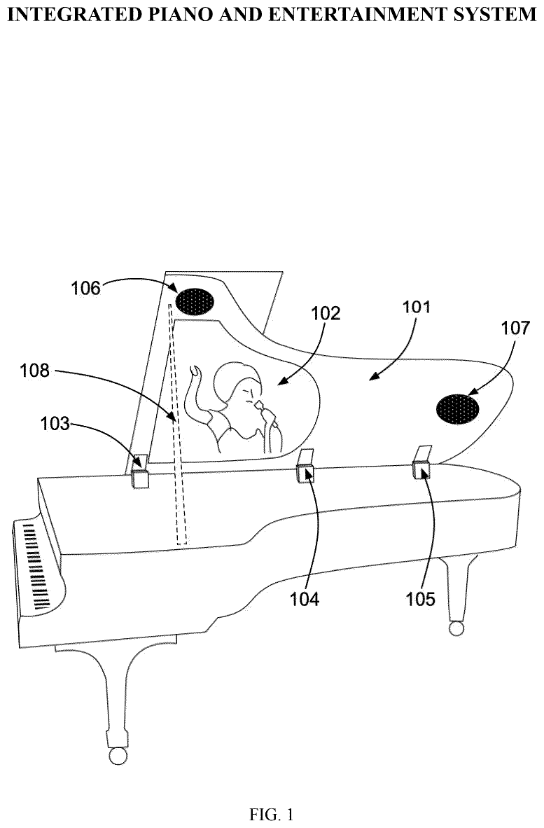

As shown in FIG. 1, a screen (102) connected to the underside of the piano lid (101) displays pre-recorded or live videos, images or text, synchronized with pre-recorded player piano performances (or live performances if camera is attached.)

### Elimination of supporting piano lid stick.

It is desirable to eliminate the supporting stick when displaying images on the piano lid as it can slightly obstruct the audience's view. As shown in FIG. 1, multiple hinge assists (103, 104, 105) keep the piano lid propped open. If the piano lid is constructed of lighter materials (plastic, acrylic, etc.) than a traditional heavier wood lid and the embedded electronics are similarly light (such as an ultra-thin OLED video display) this invention can eliminate the need for the supporting stick (108).

### Speakers Embedded Inside a Piano Lid

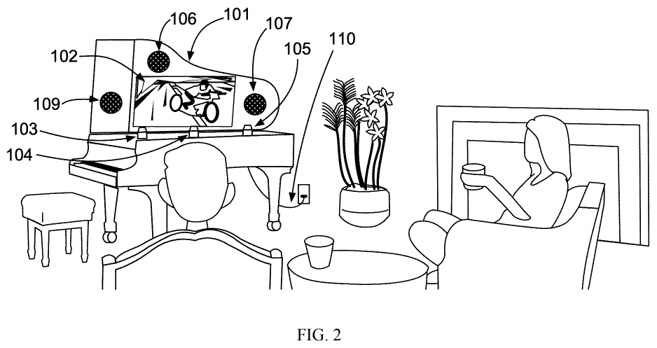

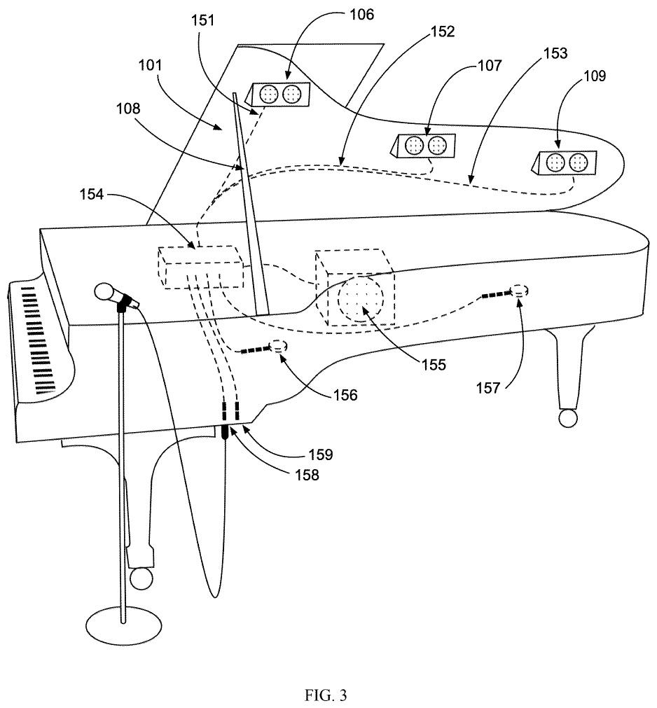

Some current entertainment player piano systems (e.g., PianoDisk (Mason Hamlin), Disklavier (Yamaha)) have speakers mounted to the underbelly of the piano. This placement is suitable for the subwoofers, but not for the tweeters which should be placed higher up and without obstructions. FIG. 1, FIG. 2 and FIG. 3 illustrate placement of the tweeter speakers (106, 107, 109) directly inside the piano lid (101) for optimal sound quality. Optionally, for live performers, these speakers can be used to amplify the piano, other musicians, singers, announcers, etc.

### Piano as Home Entertainment Center

As shown in FIG. 2, the aforementioned features (featherlight piano lid (101), embedded video screen (102), speakers (106, 107, 108), hinge assists (103, 104, 105), allow the lid to maintain a more vertical position without a supporting stick, and facilitates a grand piano to become a home entertainment center apart from its function as a musical instrument.

This is advantageous to those wishing to keep their living room free of electronics and cables—when the piano lid (101) is shut, the only sign of electronics is a single power cable (110).

FIG. 3 illustrates an embodiment with the audio features but not video features. Speakers (106, 107, 109) are attached to or embedded in the underside of the piano lid. Audio cables (151, 152, 153) embedded inside the lid connect to an amplifier (154) hidden in the underbelly of the piano. Also hidden in the piano could be: other speakers (155), microphones (156, 157), input jack(s) (158) and output jack(s) (159).

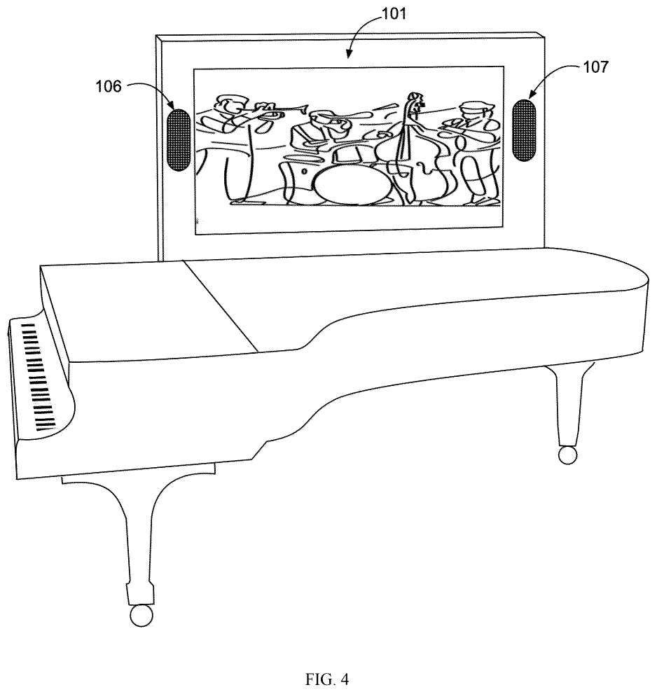

FIG. 4 illustrates another embodiment of the invention where the piano lid remains in a vertical position. Instead of the lid shutting by way of a hinge, the lid may be lowered behind the piano so as to disappear from view.

### Projector and Camera Attachment

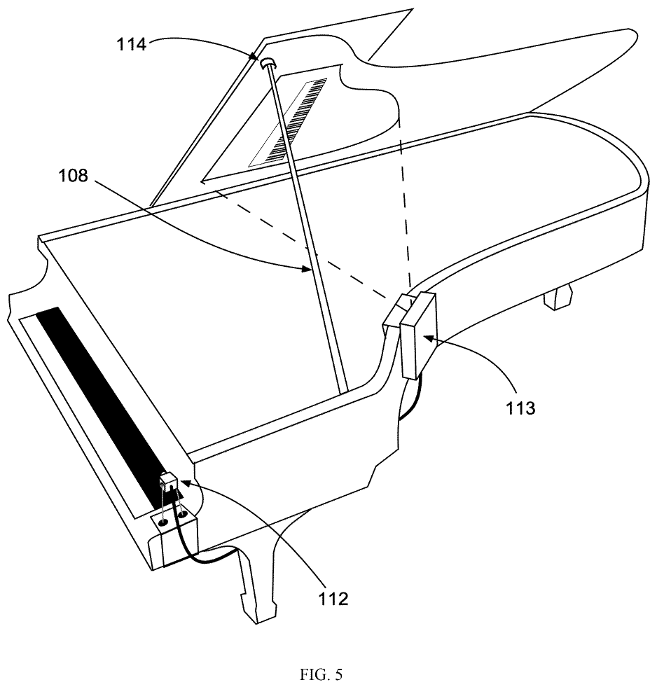

As shown in FIG. 5, a set of structures attach a camera (112) and projector (113) to the piano. This method of attachment will allow the piano to be moved onstage or its placement onstage adjusted without having to reposition the camera (112) or projector (113). Other attachment options (such as a semi-stationary basket that can hold a projector while it is rolled out on stage) are also part of this invention.

### Stick Holder Tip Reinforcement

Additional embodiments include improvements to the piano lid support infrastructure. FIG. 5 illustrates a circular cup (114) that reinforces the placement of the supporting stick (108) to minimize slippage and stick movement.

### Extended Stick With Adjustable Length

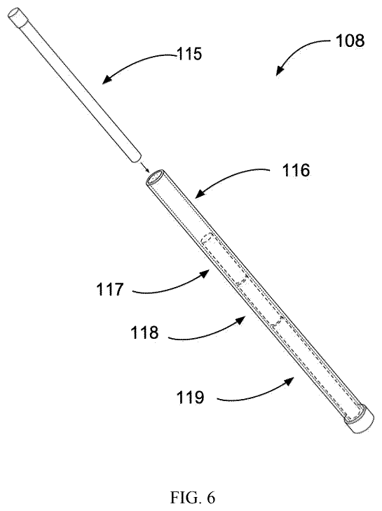

A longer-than-normal supporting stick (108) is necessary to raise the lid (101) high enough to offer a good view of the screen (102). FIG. 6 provides an extended supporting stick (108) that is both adjustable and stable. A smaller diameter cylindrical member (115) is preferably solid (not hollow) and fits inside a wider hollow pipe (116). The stick's length is adjusted by inserting or removing spacers (117, 118, 119) from within the wider pipe (116).

### Transparent Video Display on Clear Piano Lid

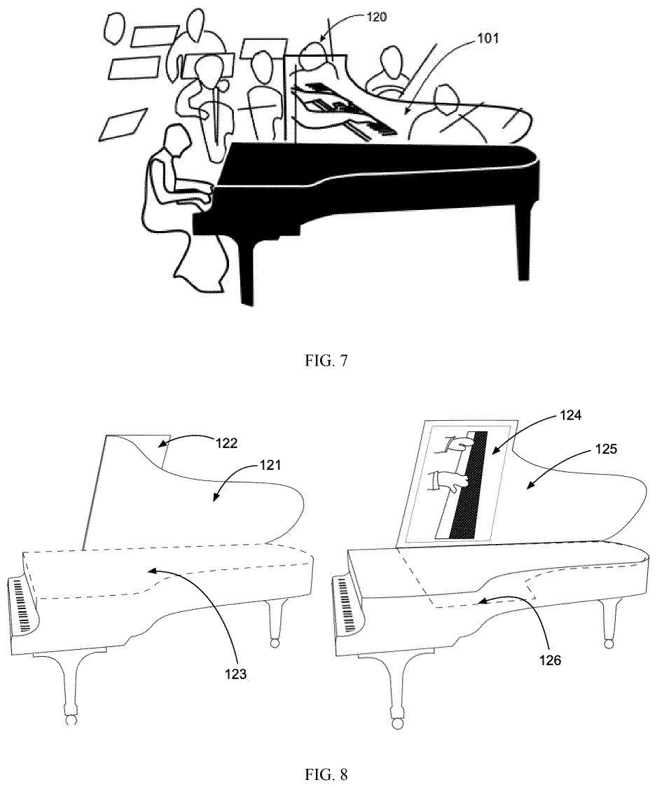

In one embodiment (FIG. 7), a transparent digital display is embedded within a transparent lid (101) for purposes of displaying images of the keys and pianist's hands. Visual transparency to objects behind the piano lid is especially desired in a piano concerto performance (with full orchestra and conductor) as the normal opaque piano lid frequently blocks the audience's view of the conductor (120) and some of the orchestral players. This invention creates a more direct view of all player participants (through the transparent lid) while incorporating enhanced digital imagery, within a live performance.

### Altered Piano Lid Shape

As shown in FIG. 8, a normal piano lid consists of the large “rear lid” (121) and the smaller “front lid” (122), here shown in concert position with the front lid (122) folded behind the rear lid (121). When the lid is closed in storage position, the rear lid (121) and front lid (122) conform to the basic “aerial shape” (topology) (123) of the piano. In this embodiment, in order to accommodate the size of commercially available video displays rotated to portrait mode (124), the rear lid (121) and front lid (122) are combined into one single piece (125). The familiar piano-lid silhouette is maintained for aesthetic reasons, but now when the lid is shut, this new lid (125) does not conform to the shape of the body as indicated in the dotted lines (126). In fact, because of the expense of creating such a lid, it could travel with a concert pianist and be attached to each piano along a concert tour.

### Screen Design Encompasses Both Piano Lid Shape and 16:9 Aspect Ratio

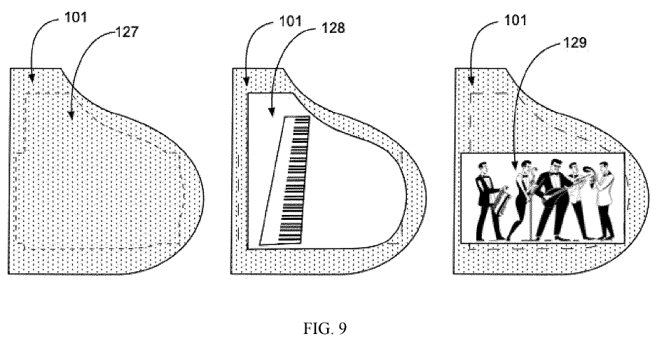

As shown in FIG. 9, a video display screen (127) is designed to assume either the optimal shape for live concerts (128) or the 16:9-screen-ratio shape for most movies and videos (129). During construction of the lid (101), materials and the shade of black are chosen to match as much as possible the color and sheen of black found on a display screen (127), the goal being to make the viewer unaware of the screen's (121) unusual shape. (Preferably the viewer will be unaware that the display screen exists when it is turned off.)

### Image Manipulation for Image Projection

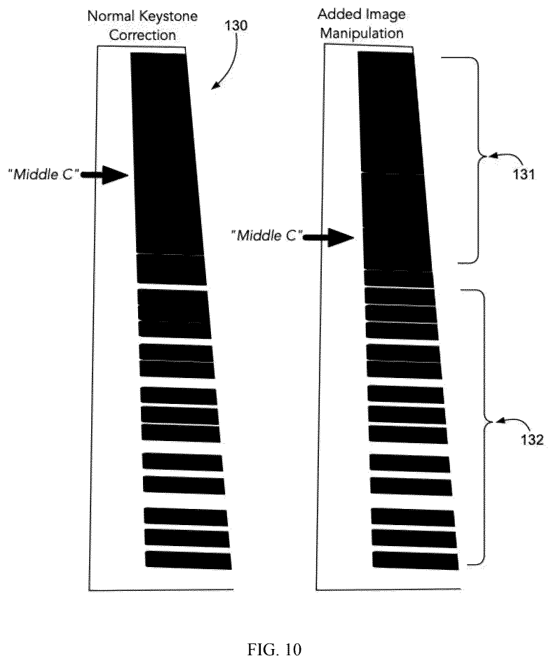

Displaying VIDEO on the underside of a piano lid (101) involves as many as three unusual angles: If the lid is tilted (not vertical), an image on the underside of the lid will appear skewed to the viewers'eyes. If a projector projects an image onto such a tilted lid, the projected image will be further skewed. Finally, if a camera is used to show the hands and keyboard at live concerts and it is not positioned directly above the keyboard, the image will show a perspective view such that one end of the keyboard will appear closer than the other end. The result of this combination of angles can be a distorted image not amenable to simple keystone correction. As shown in FIG. 10, commercial projectors offer some helpful “keystone” corrections (130). However, further image manipulation is desired; the present invention uses a microcode embedded microprocessor (such as a smart tablet or Raspberry Pi) or a reconfigurable hardware device that can be programmed to implement custom digital logic circuits such as an FPGA (Field Programmable Gate Array) to make the projected images appear more realistic. Especially desired is to elongate the top half of the image (131) and compress the lower half (132) so that the range of the keyboard appears more evenly spaced.

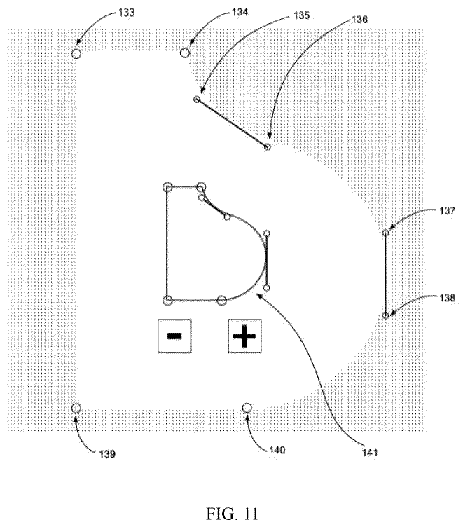

Further, the microprocessor or hardware device will mask the image if a non-rectangular screen (102) is employed. As shown in FIG. 11, an intuitive graphical user interface would be projected directly onto the screen by an interactive projector during setup mode. The user would drag the circles (133, 134, 135, 136, 137, 138, 139, 140) with a stylus or a finger until the shape, size and mask of the image is correct. Note: the miniature model (141) in the middle of the interface would be used if the image appears so big that the outside handles (133, 134, 135, etc.) are out of view.

### Tablet Enclosure

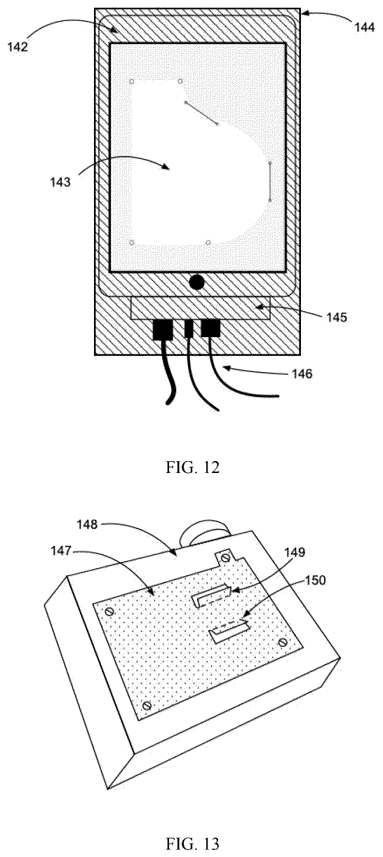

Alternatively, as illustrated in FIG. 12, a smart computer tablet (142) can offer a similar graphical user interface (143) to shape, size and mask the image. The smart computer tablet (142) also provides local storage of image and video files, and facilitates the switching of digital sources between camera and image/video files during a live performance. The tablet (142) would normally be hidden from the audience's view, but during setup, the user will move it in front of the piano screen. Because the computer tablet may frequently be moved around, this invention embodies a housing (144) that holds firmly in place: the tablet (142), adapter hub (145), and cables (146).

### Projector Plate

When a projector is used to display the image, it may be set on a camera tripod in front of the screen, usually with a pistol grip ball head for easy adjustment. FIG. 13 displays a plate (147) that attaches to the bottom of the projector (148). Two “flaps” (149, 150) cut out of the same plate and bent up allow for a secure connection onto a tripod mount. This single plate of metal is simple and secure.

### ALTERNATIVE EMBODIMENTS

The present invention can be equipped with audio and video jacks so that a player piano can be connected with external speakers and video displays.

### Hologram-Like and 3D Image Projection System That Projects Holograms

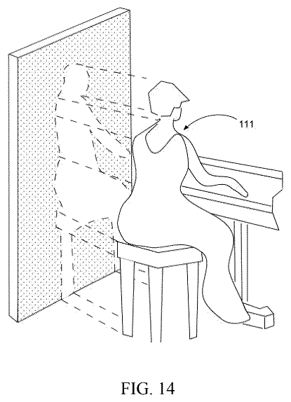

FIG. 14 illustrates an alternative embodiment, a hologram-like virtual image (111) projected (towards the audience) from a broad-spectrum complex-amplitude dense converging wavefront display that projects a hologram-like appearance of a pianist to the audience so that it appears at the location of the bench. The projection of the pianist would synchronize movement of the pianist with motions of the player piano. Proprietary custom modeling methods using, e.g., artificial intelligence, could be employed for re-enacting historic performances and musical mannerisms of musicians and composers alike. People could enjoy and learn from historically modeled pianists such as Rachmaninoff or Horowitz-or simply enjoy a recently recorded full concert performance within the piano entertainment system.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments.

Although the invention has been set forth in terms of the exemplary embodiments described herein and illustrated in the attached figures, it is to be understood that such descriptions are purely illustrative and are not to be interpreted as limiting. Consequently, various alterations, modifications, and/or alternative embodiments and applications may be suggested to those skilled in the art after having read this disclosure. Accordingly, it is intended that the invention be interpreted as encompassing all alterations, modifications, or alternative embodiments and applications as fall within the spirit and scope of this disclosure.

It will be further understood that various changes in the details, materials, and arrangements of the parts which have been described and illustrated in order to explain the nature of this disclosure may be made by those skilled in the art without departing from the scope of the disclosure as expressed in the following claims.

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

1. A method for enhanced use of a grand piano having a player piano mechanism, comprising:
(a) holding a player piano lid open to at least 50 degrees relative to horizontal,
(b) displaying video on a portion of the underside of the piano lid,
(c) playing a pre-recorded player piano performance that is synchronized with said video.

2. The method of claim 1, wherein audio speakers are embedded in or attached to the lid of said grand piano.

3. The method of claim 1, wherein hinge assists negate the need for a supporting stick to hold up the lid.

4. The method of claim 1, wherein a projector and/or camera are attached to some part of the piano.

5. The method of claim 1, wherein the piano lid is transparent, and a transparent OLED digital display is embedded in or attached to the lid.

6. The method of claim 1, wherein a supporting stick is constructed of:
(a) a hollow pipe;
(b) cylindrical spacers that can be placed inside the hollow pipe;
(c) a cylindrical member that fits inside the hollow pipe and on top of the cylindrical spacers, so that the number of said spacers determine the total length of the supporting stick.

7. The method of claim 1, wherein the open lid has the following characteristics:
(a) is a single unit (not a rear lid connected via a piano hinge to a front lid);
(b) maintains a recognizable silhouette of an open grand piano lid;
(c) contains a video display inlaid within its boundaries;
(d) when in the closed position, the lid does not conform to the “aerial shape” (topology) of the grand piano it is attached to.

8. The method of claim 1, wherein the shape and size of a video display embedded in or attached to the lid, fulfills these requirements:
(a) allows for the full unmasked display of a standard 16:9 landscape-mode video image, such that the left edge of the image is no more than 6 inches from the left edge of the rear lid (from the audience's point of view), and the right edge of the image is no more than 8 inches from the right most point of the lid from the audience's point of view;
(b) allows for a masked display of the entire range of an 88-key keyboard, such that the topmost edge of the image is not more than 15 inches from the topmost edge of the rear piano lid, when the lid is open, and the bottom most edge of the image is not more than 10 inches from the bottom most edge of the piano lid when the lid is open;
(c) no part of the screen overlaps the boundaries of the piano lid.

9. The method of claim 1, wherein a microcode embedded microprocessor or a reconfigurable hardware device that can be programmed to implement custom digital logic circuits manipulates the image to minimize distortion (perceived or real) due to one or more of the following non-90-degree angles: camera-to-keyboard, projector-to-lid, audience's-eyes-to-lid.

10. The method of claim 9, wherein said microprocessor is a smart tablet or Raspberry Pi.

11. The method of claim 9, wherein said reconfigurable hardware device is a FPGA (Field Programmable Gate Array.)

12. The method of claim 1, wherein an enclosure holds firmly in place a smart tablet, adapters, and cables.

13. The method of claim 1, wherein a metal plate connects a projector to a mount on a camera tripod, said metal plate having two flaps cut into the metal and bent up so that they have the correct dimensions to fit securely inside the mount.

14. The method of claim 1, wherein embedded microphones can amplify the piano through speakers embedded in the lid and underbelly of the piano.

15. A method for enhanced use of a grand piano wherein audio speakers are embedded in or attached to the lid of a grand piano.

16. A method for enhanced use of a player piano, comprising: projecting a hologram-like image at the piano bench, such that the hologram-like image appears to play the piano synchronized with a pre-recorded performance of the player piano.
